(19) United States
(12) Patent Application Publication
(10) Pub. No.: US 2026/0112707 A1
(43) Pub. Date: Apr. 23, 2026

(54) ELECTRODE MANUFACTURING DEVICE AND ELECTRODE MANUFACTURING METHOD

(71) Applicant: SAMSUNG SDI CO., LTD., Yongin-si (KR)

(72) Inventor: Seok Gyun PARK, Suwon-si (KR)

(21) Appl. No.: 19/348,543

(22) Filed: Oct. 2, 2025

(30) Foreign Application Priority Data
Oct. 22, 2024 (KR) 10-2024-0145011

(51) Int. Cl. H01M 10/0587

(52) U.S. Cl. CPC H01M 10/0587

(57) ABSTRACT

An electrode manufacturing device includes a winding unit configured to wind an electrode plate including an active material layer on a substrate into a wound electrode plate, and a jig configured to fix an outside of the wound electrode plate and prevent expansion of the wound electrode plate. The electrode manufacturing device is configured to control spring back of the electrode plate and/or improve thickness dispersion of the electrode plate.

### CROSS-REFERENCE TO RELATED APPLICATION

The present application claims priority to and the benefit of Korean Patent Application No. 10-2024-0145011, filed on Oct. 22, 2024, in the Korean Intellectual Property Office, the entire disclosure of which is incorporated herein by reference.

### BACKGROUND

### 1. Field

The present disclosure relates to an electrode manufacturing device and an electrode manufacturing method.

### 2. Discussion of Related Art

Secondary batteries are batteries that can be charged and discharged, unlike primary batteries that cannot be recharged. Low-capacity secondary batteries are used in small portable electronic devices such as smartphones, feature phones, laptop computers, digital cameras, and camcorders, and high-capacity secondary batteries are widely used as motor driving power sources, power storage batteries, and the like in hybrid vehicles, electric vehicles, and the like. These secondary batteries include electrode(s) including a positive electrode and/or a negative electrode, an electrode assembly including the electrode(s), a case which accommodates the electrode assembly, and an electrode terminal connected to the electrode assembly.

The above-described information disclosed in the background technology of the present disclosure is only for improving understanding of the background of the present disclosure, and accordingly, may include information that does not constitute the related art.

### SUMMARY

One embodiment of the present disclosure is directed to providing an electrode manufacturing device and/or an electrode manufacturing method configured to control expansion of an electrode plate during a process of manufacturing an electrode.

Another embodiment of the present disclosure is directed to providing an electrode manufacturing device and/or an electrode manufacturing method configured to control spring back during a process of manufacturing an electrode.

However, technical problems to be solved by the present disclosure are not limited to the above-described problems, and other problems which are not mentioned, will be clearly understood by those skilled in the art from the description of the invention disclosed below.

An electrode manufacturing device according to one embodiment of the present disclosure includes: a winding unit configured to wind an electrode plate including an active material layer on a substrate; and a jig configured to fix an outside of the wound electrode plate and to prevent expansion of the electrode plate.

An electrode manufacturing method according to one embodiment of the present disclosure includes: winding, by a winding unit, an electrode plate to form a wound electrode plate; and fixing, by a jig, an outer circumferential surface of the wound electrode plate to form a fixed electrode plate.

### BRIEF DESCRIPTION OF THE DRAWINGS

The following drawings attached to this specification illustrate preferred embodiments of the present invention and, together with the detailed description of the invention to be described below, serve to further understand the technical idea of the present invention, and therefore the present invention should not be construed as being limited to matters described in such drawings, in which:

FIGS. 1 to 4 are cross-sectional views schematically depicting a secondary battery according to one embodiment of the present disclosure;

FIG. 5 is a view schematically depicting a state in which an electrode plate according to one embodiment of the present disclosure is unfolded;

FIG. 6 is a view schematically depicting an electrode manufacturing device winding the electrode plate;

FIG. 7 is a view schematically depicting an electrode manufacturing device according to one embodiment of the present disclosure winding the electrode plate;

FIG. 8 is a flowchart depicting aspects of an electrode manufacturing method according to one embodiment of the present disclosure;

FIG. 9 depicts a jig according to one embodiment of the present disclosure; and

FIG. 10 depicts a jig according to one embodiment of the present disclosure.

### DETAILED DESCRIPTION

Hereinafter, embodiments of the present disclosure will be described in detail. However, these embodiments are presented as examples and are not intended to limit the present disclosure, and the present disclosure is only defined by the scope of the following claims.

Unless otherwise specifically mentioned in the present specification, a case in which a part such as a layer, a film, a region, a plate, or the like is “on” another part includes not only a case in which the part is “directly on” another part, but also a case in which there is still another part therebetween.

Unless otherwise specifically mentioned in the present specification, a singular form may also include a plural form. In addition, unless otherwise specifically mentioned, “A or B” may mean “including A, including B, or including A and B”.

In the present specification, “a combinations thereof” may mean a mixture, a laminate, a compound, a copolymer, an alloy, a blend, and a reaction product of compositions.

Unless otherwise separately defined in the present specification, a particle diameter may be an average particle diameter. The particle diameter also means an average particle diameter (D50) which is a diameter of particles with a cumulative volume of 50% by volume in the particle size distribution. The average particle diameter (D50) may be measured by methods widely known to those skilled in the art, for example, by a particle size analyzer, or may be measured by transmission electron micrographs or scanning electron micrographs. Alternatively, the average particle diameter (D50) may be acquired by measuring the average particle diameter (D50) using a measurement device using a dynamic light scattering method, performing data analysis to count the number of particles in each particle size range, and then calculating the average particle diameter (D50) therefrom. Alternatively, the average particle diameter (D50) may be measured using a laser diffraction method. When the average particle diameter (D50) is measured using the laser diffraction method, more specifically, after dispersing the particles to be measured in a dispersion medium and then introducing the particles into a commercially available laser diffraction particle size measurement device (for example, Microtrac MT 3000) and irradiating ultrasonic waves of about 28 kHz at power of 60 W, the average particle size (D50) based on 50% of the particle size distribution in the measurement device may be calculated.

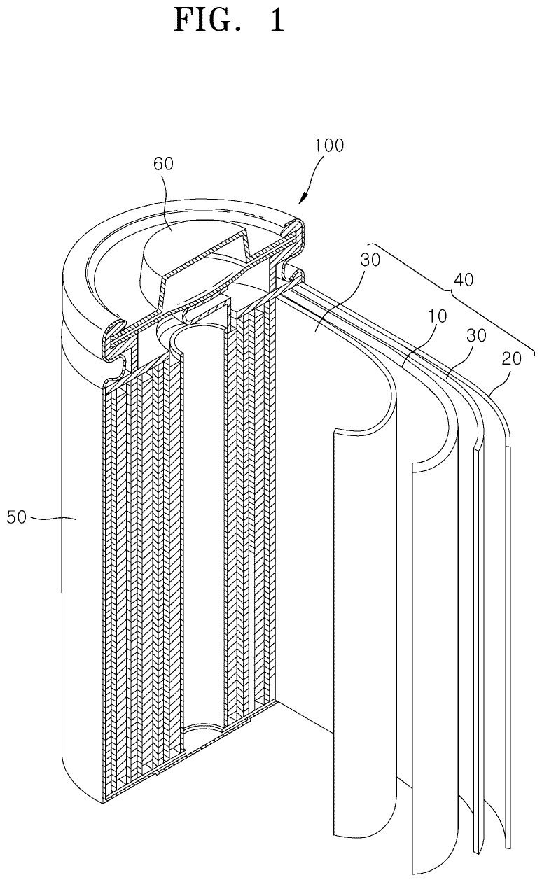

FIGS. 1 to 4 are cross-sectional views schematically showing a secondary battery 100 according to various embodiments of the present disclosure.

### Secondary Battery

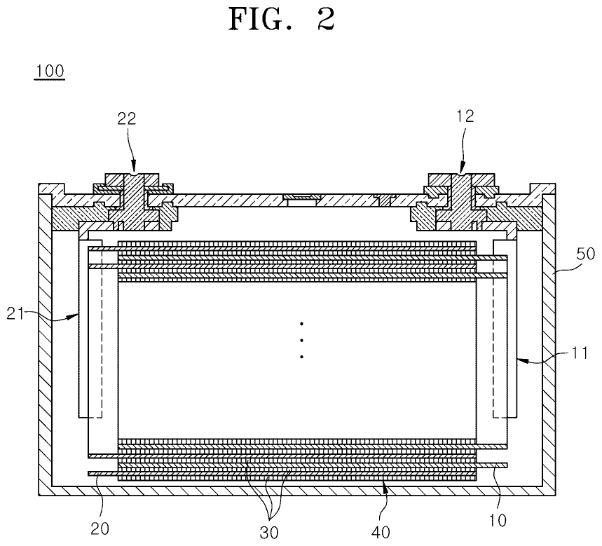

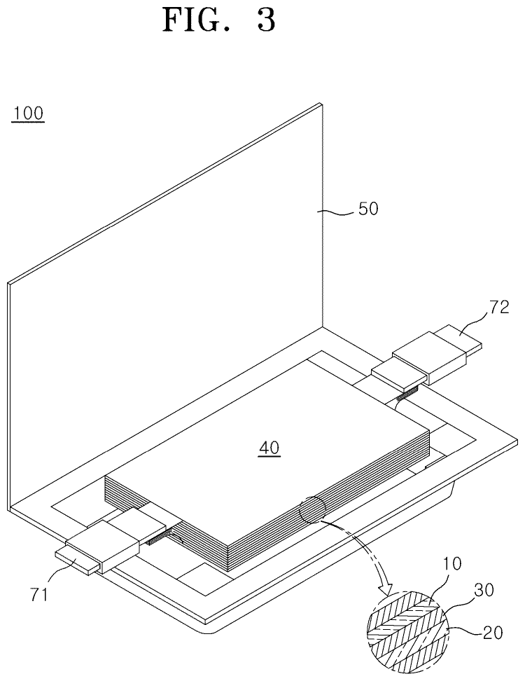

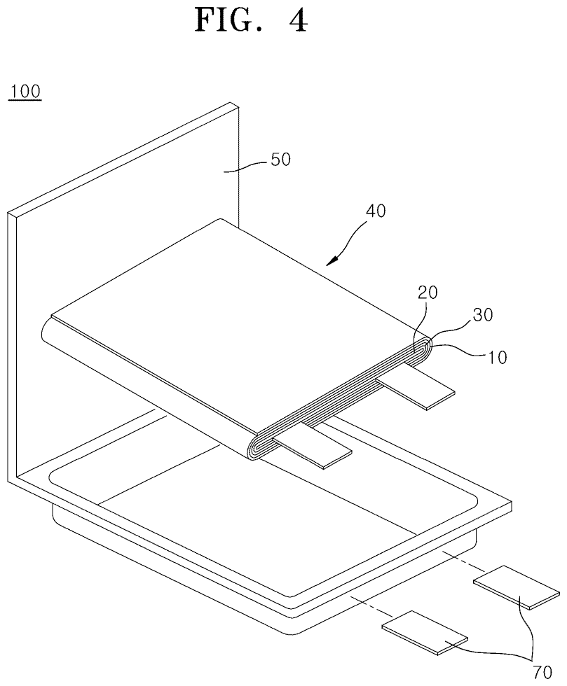

The secondary battery 100 may be classified into a cylindrical type, a prismatic type, a pouch type, a coin type, or the like depending on its shape. FIGS. 1-4 are schematic views depicting the secondary battery 100 according to various embodiments in which FIG. 1 depicts a cylindrical battery, FIG. 2 depicts a prismatic battery, and FIGS. 3 and 4 depict a pouch-type battery. Referring to FIGS. 1 to 4, the secondary battery 100 may include an electrode assembly 40 in which a separator 30 is interposed between a positive electrode 10 and a negative electrode 20, and a case 50 in which the electrode assembly 40 is accommodated. The positive electrode 10, the negative electrode 20, and the separator 30 may be impregnated with an electrolyte. As shown in FIG. 1, the secondary battery 100 may include a sealing member 60 which seals the case 50. Further, in FIG. 2, the secondary battery 100 may include a positive electrode lead tab 11, a positive electrode terminal 12, a negative electrode lead tab 21, and a negative electrode terminal 22. As shown in FIGS. 3 and 4, the secondary battery 100 may include electrode tabs 70, that is, a positive electrode tab 71 and a negative electrode tab 72, which serve as an electrical path for guiding a current generated in the electrode assembly 40 to the outside.

### Positive Electrode Active Material

A compound capable of reversibly intercalating and deintercalating lithium (a lithiated intercalation compound) may be used as the positive electrode active material. In one or more embodiments, one or more types of a composite oxide of lithium and a metal selected from cobalt, manganese, nickel, and a combination thereof may be utilized.

The composite oxide may be a lithium transition metal composite oxide. In one or more embodiments, the composite oxide may include lithium nickel-based oxide, lithium cobalt-based oxide, lithium manganese-based oxide, lithium iron phosphate-based compound, cobalt-free nickel-manganese-based oxide, or a combination thereof.

For example, a compound represented by any one of the chemical formulas below may be utilized: LiₐA_{1-b}X_{b}O_{2-c}D_{c} (0.90≤a≤1.8, 0≤b≤0.5, 0≤c≤0.05); LiₐMn_{2-b}X_{b}O_{4-c} D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above chemical formulas, A is Ni, Co, Mn, or a combination thereof, X is Al, Ni, Co, Mn, Cr, Fe, Mg, Sr, V, a rare earth element, or a combination thereof, D is O, F, S, P, or a combination thereof, G is Al, Cr, Mn, Fe, Mg, La, Ce, Sr, V, or a combination thereof, and L¹ is Mn, Al, or a combination thereof.

In one or more embodiments, the positive electrode active material may be a high nickel-based positive electrode active material having a nickel content of approximately 80 mol % or more, approximately 85 mol % or more, approximately 90 mol % or more, approximately 91 mol % or more, or approximately 94 mol % or more and approximately 99 mol % or less based on 100 mol % of metals excluding lithium in the lithium transition metal composite oxide. The high nickel-based positive electrode active material may exhibit or achieve high capacity, and thus may be applied to high capacity, high density secondary batteries.

### Positive Electrode

The positive electrode 10 for the secondary battery 100 may include a current collector and a positive electrode active material layer on the current collector. The positive electrode active material layer may include a positive electrode active material and a binder and/or a conductive material.

For example, the positive electrode may include an additive configured to function as a sacrificial positive electrode.

A content of the positive electrode active material may be in a range from approximately 90% to approximately 99.5% by weight based on 100% by weight of the positive electrode active material layer and a content of the binder and the conductive material may each be in a range from approximately 0.5% to approximately 5% by weight based on 100% by weight of the positive electrode active material layer.

The binder serves to attach particles constituting the positive electrode active material to each other, and also to attach the positive electrode active material to the current collector. In one or more embodiments, the binder may include polyvinyl alcohol, carboxymethylcellulose, hydroxypropylcellulose, diacetylcellulose, polyvinyl chloride, carboxylated polyvinyl chloride, polyvinyl fluoride, polymers containing ethylene oxide, polyvinylpyrrolidone, polyurethane, polytetrafluoroethylene, polyvinylidene fluoride, polyethylene, polypropylene, styrene-butadiene rubber, (meth)acrylated styrene-butadiene rubber, an epoxy resin, a (meth)acrylic resin, a polyester resin, nylon, or the like, but the present disclosure is not limited thereto.

The conductive material is used to impart conductivity to the electrode, and any material which does not cause a chemical change and is electronically conductive may be utilized. In one or more embodiments, the conductive material may include a carbon-based material such as natural graphite, artificial graphite, carbon black, acetylene black, Ketjen black, carbon fibers, carbon nanofibers, carbon nanotubes, or the like, a metal-based material in the form of metal powder or metal fibers containing copper, nickel, aluminum, silver, or the like, a conductive polymer such as a polyphenylene derivative or the like, or a mixture thereof.

In one or more embodiments, Al may be used as the current collector, but the current collector is not limited thereto.

### Negative Electrode Active Material

The negative electrode active material includes a material configured to reversibly intercalating and deintercalating lithium ions, lithium metal, an alloy of lithium and a metal, a material capable of doping and dedoping lithium, or a transition metal oxide.

The material capable of reversibly intercalating and deintercalating lithium ions may include a carbon-based negative electrode active material, for example, crystalline carbon, amorphous carbon, or a combination thereof. In one or more embodiments, the crystalline carbon may include graphite such as amorphous, plate-shaped, flaky, spherical, or fibrous natural graphite or artificial graphite, and the amorphous carbon may include soft carbon or hard carbon, mesophase pitch carbide, calcined coke, or the like.

An alloy of lithium and a metal selected from Na, K, Rb, Cs, Fr, Be, Mg, Ca, Sr, Si, Sb, Pb, In, Zn, Ba, Ra, Ge, Al, and Sn may be utilized as the alloy of lithium and a metal.

A Si-based negative electrode active material or a Sn-based negative electrode active material may be utilized as the material capable of doping and dedoping lithium. The Si-based negative electrode active material may include silicon, a silicon-carbon composite, SiOₓ (0<x<2), an Si-Q alloy (Q is selected from an alkali metal, an alkaline earth metal, a Group 13 element, a Group 14 element (excluding Si), a Group 15 element, a Group 16 element, a transition metal, a rare earth element, and a combination thereof), or a combination thereof. The Sn-based negative electrode active material may be Sn, SnO₂, a Sn-based alloy, or a combination thereof.

The silicon-carbon composite may be a composite of silicon and amorphous carbon. According to one embodiment, the silicon-carbon composite may be in the form of silicon particles whose surfaces are coated with amorphous carbon. For example, the silicon-carbon composite may include a secondary particle (a core) in which silicon primary particles are assembled, and an amorphous carbon coating layer (a shell) on the surface of the secondary particle. The amorphous carbon may also be located between the silicon primary particles, and for example, the silicon primary particles may be coated with amorphous carbon. The secondary particles may be dispersed in an amorphous carbon matrix.

The silicon-carbon composite may further include crystalline carbon. For example, the silicon-carbon composite may include a core containing crystalline carbon and silicon particles, and an amorphous carbon coating layer on the surface of the core.

The Si-based negative electrode active material or the Sn-based negative electrode active material may be utilized in combination with the carbon-based negative electrode active material.

### Negative Electrode

The negative electrode 20 for the secondary battery 100 may include a current collector and a negative electrode active material layer on the current collector. The negative electrode active material layer may include a negative electrode active material and a binder and/or a conductive material.

In one or more embodiments, the negative electrode active material layer may include the negative electrode active material in an amount in a range from approximately 90% to approximately 99.5% by weight, the binder in an amount in a range from approximately 0.5% to approximately 5% by weight, and the conductive material in an amount in a range from approximately 0% to approximately 5% by weight

The binder is configured to attach particles constituting the negative electrode active material to each other, and also to attach the negative electrode active material to the current collector. The binder may be a non-aqueous binder, an aqueous binder, a dry binder, or a combination thereof

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenol resin, an epoxy resin, polyvinyl alcohol, or a combination thereof.

In an embodiment in which the aqueous binder is utilized as the negative electrode binder, a cellulose-based compound capable of imparting viscosity may be further included. As the cellulose-based compound, one or more of carboxymethyl cellulose, hydroxypropylmethyl cellulose, methyl cellulose, and/or alkali metal salts thereof may be used in combination. Na, K, or Li may be utilized as the alkali metal.

The dry binder is a polymer material which may be fiberized and may be, for example, polytetrafluoroethylene, polyvinylidene fluoride, a polyvinylidene fluoride-hexafluoropropylene copolymer, polyethylene oxide, or a combination thereof.

The conductive material is used to impart conductivity to the electrode, and any material which does not cause a chemical change and is electronically conductive may be utilized. In one or more embodiments, the conductive material may include a carbon-based material such as natural graphite, artificial graphite, carbon black, acetylene black, Ketjen black, carbon fibers, carbon nanofibers, carbon nanotubes, or the like, a metal-based material in the form of metal powder or metal fibers containing copper, nickel, aluminum, silver, or the like, a conductive polymer such as a polyphenylene derivative or the like, or a mixture thereof.

The negative electrode current collector may be selected from copper foil, nickel foil, stainless steel foil, titanium foil, nickel foam, copper foam, a polymer substrate coated with a conductive metal, or a combination thereof.

### Electrolyte

The electrolyte for the secondary battery 100 includes a non-aqueous organic solvent and a lithium salt.

The non-aqueous organic solvent serves as a medium through which ions involved in an electrochemical reaction of the battery may move (or flow).

The non-aqueous organic solvent may be a carbonate-based solvent, an ester-based solvent, an ether-based solvent, a ketone-based solvent, an alcohol-based solvent, an aprotic solvent, or a combination thereof.

In one or more embodiments, the carbonate-based solvent may be dimethyl carbonate (DMC), diethyl carbonate (DEC), dipropyl carbonate (DPC), methyl propyl carbonate (MPC), ethyl propyl carbonate (EPC), methyl ethyl carbonate (MEC), ethylene carbonate (EC), propylene carbonate (PC), butylene carbonate (BC), or the like.

In one or more embodiments, the ester-based solvent may be methyl acetate, ethyl acetate, n-propyl acetate, dimethyl acetate, methyl propionate, ethyl propionate, decanolide, mevalonolactone, valerolactone, caprolactone, or the like.

In one or more embodiments, the ether-based solvent may be dibutyl ether, tetraglyme, diglyme, dimethoxyethane, 2-methyltetrahydrofuran, 2,5-dimethyltetrahydrofuran, tetrahydrofuran, tetrahydrofuran, or the like. In one or more embodiments, the ketone-based solvent may be cyclohexanone. In one or more embodiments, the alcohol-based solvent may be ethyl alcohol, isopropyl alcohol, or the like. In one or more embodiments, the aprotic solvent may be nitriles such as R—CN (R is a linear, branched, or cyclic hydrocarbon group having 2 to 20 carbon atoms and may include double bonds, an aromatic ring, or an ether group) or the like, amides such as dimethylformamide or the like, dioxolanes such as 1,3-dioxolane, 1,4-dioxolane, or the like, sulfolanes, or the like.

The non-aqueous organic solvent may be used alone or in a mixture of two or more.

Further, in an embodiment in which the carbonate-based solvent is utilized, a mixture of a cyclic carbonate and a chain carbonate may be utilized, and the cyclic carbonate and the chain carbonate may be mixed in a volume ratio in a range from approximately 1:1 to approximately 1:9.

The lithium salt is a material which dissolves in an organic solvent and serves as a source of lithium ions in the battery to enable the basic operation of a secondary battery and to promote the movement of lithium ions between the positive electrode and the negative electrode. In one or more embodiments, the lithium salts may include one or more of LiPF₆, LiBF₄, LiSbF₆, LiAsF₆, LiClO₄, LiAlO₂, LiAlCl₄, LiPO₂F₂, LiCl, LiI, LIN(SO₃C₂F₅)₂, Li(FSO₂)₂N (lithium bis(fluorosulfonyl)imide (LiFSI), LiC₄F₉SO₃, LIN(CₓF₂ₓ₊₁SO₂)(C_{y}F_{2y+1}SO₂) (x and y are integers from 1 to 20), lithium trifluoromethane sulfonate, lithium tetrafluoroethanesulfonate, lithium difluorobis(oxalato)phosphate (LiDFOB), or lithium bis(oxalato) borate (LiBOB).

### Separator

The separator 30 may be between the positive electrode 10 and the negative electrode 20 depending on the type of secondary battery 100. In one or more embodiments, the separator 30 may be (or include) polyethylene, polypropylene, polyvinylidene fluoride, or a multilayer film of two or more layers thereof, or a mixed multilayer film such as a polyethylene/polypropylene two-layer separator, a polyethylene/polypropylene/polyethylene three-layer separator, a polypropylene/polyethylene/polypropylene three-layer separator, or the like.

The separator 30 may include a porous substrate and a coating layer containing an organic material, an inorganic material, or a combination thereof on one side or both sides of the porous substrate.

The porous substrate may be a polymer film formed of (or including) one polymer selected from polyolefins such as polyethylene and polypropylene, polyesters such as polyethylene terephthalate and polybutylene terephthalate, polyacetal, polyamide, polyimide, polycarbonate, polyetherketone, polyaryletherketone, polyetherimide, polyamideimide, polybenzimidazole, polyether sulfone, polyphenylene oxide, a cyclic olefin copolymer, polyphenylene sulfide, polyethylene naphthalate, glass fibers, Teflon, and polytetrafluoroethylene or a copolymer or mixture of two or more thereof.

The organic material may include a polyvinylidene fluoride-based polymer or a (meth)acrylic-based polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but the present disclosure is not limited thereto.

The organic material and the inorganic material may be a mixture in one coating layer, or the organic material and the inorganic material may be stacked in separate coating layers (i.e., a coating layer containing an organic material and a coating layer containing an inorganic material that are stacked).

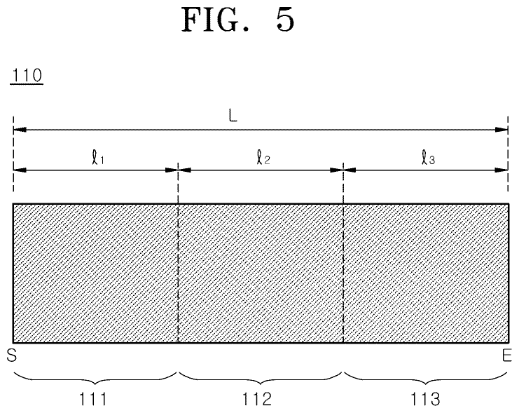

FIG. 5 is a view schematically showing a state or configuration in which an electrode plate according to one embodiment of the present disclosure is unfolded.

In FIG. 5, reference number 110 represents an electrode plate.

The electrode plate 110 is a component of an electrode. In one or more embodiments, the electrode includes, for example, the positive electrode 10 and/or the negative electrode 20 described in FIGS. 1 to 4. The electrode plate 110 is shown in FIG. 5 in a state before being manufactured into an electrode.

In one or more embodiments, the electrode plate 110 includes a substrate and an active material layer on the substrate.

In an embodiment in which the electrode plate 110 is a positive electrode plate, the substrate may include, for example, aluminum. In an embodiment in which the electrode plate 110 is a negative electrode plate, the substrate may include, for example, copper. The detailed description of the substrate and/or the active material layer is the same as or similar to description in FIGS. 1 to 4.

In one or more embodiments, the electrode plate 110 may be, for example, manufactured into the electrode by processing such as slitting, winding, and/or notching. In one or more embodiments, the electrode plate 110 may be, for example, manufactured into the electrode with a tab (including, for example, the electrode tab 70 described in FIGS. 1 to 4) attached.

In FIG. 5, L represents an entire length of the electrode plate 110 in a longitudinal direction of the electrode plate 110. In FIG. 5, S represents a starting point of the electrode plate 110. For example, the starting point S of the electrode plate may be located at a mandrel portion of the electrode plate when the electrode plate 110 is wound during a manufacturing operation. In FIG. 5, E represents an end point of the electrode plate 110. For example, the end point E of the electrode plate may be located on an outer portion of the electrode plate when the electrode plate 110 is wound during the manufacturing operation.

In FIG. 5, reference number 111 represents a mandrel region of the electrode plate 110. In one or more embodiments, the electrode plate 110 may include one mandrel region. In one or more embodiments, the mandrel region 111 represents 1/n of the entire region of the electrode plate 110. In one or more embodiments, n is a natural number greater than or equal to 2. The mandrel region 111 represents a region close (e.g. proximate) to the starting point S of the electrode plate 110. The mandrel region 111 may be formed with, for example, a length of I₁. I₁ may have, for example, a value of 1/n of L.

In FIG. 5, reference number 113 represents an outer region of the electrode plate 110. The electrode plate 110 may include one outer region 113. For example, the outer region 113 represents 1/n of the entire region of the electrode plate 110. The outer region 113 represents a region close (e.g., proximate) to the end point E of the electrode plate 110. The outer region 113 may be formed with, for example, a length of I₃. Is may have, for example, a value of 1/n of L.

In FIG. 5, reference number 112 represents an intermediate region of the electrode plate 110. The electrode plate 110 may include one or more intermediate regions 112. For example, the intermediate region 112 represents 1/n of the electrode plate 110. The intermediate region 112 represents a region between the mandrel region 111 and the outer region 113 of the electrode plate 110. The intermediate region 112 may be formed with, for example, a length of I₂. I₂ may have, for example, a value of 1/n of L. In an embodiment in which n is 2, the electrode plate 110 does not include the intermediate region 112, and the electrode plate 110 may include only the mandrel region 111 and the outer region 113.

The electrode plate 110 may undergo, for example, pressing, slitting, and drying (VD) processes.

For example, as described above, the active material layer may be applied on the substrate. The pressing process is a process of evaporating a solvent remaining in the active material layer. In one or more embodiments, the pressing process may enhance energy density and form the active material layer by compressing and hardening the active material layer on the substrate. Accordingly, an exterior of the electrode plate 110 may be completed.

For example, the pressed electrode plate 110 may be slit. The slitting process is a process of dividing and processing the electrode plate 110 into a shape of two or more electrode strips. For example, the electrode plate 110 may be divided into two or more parts and processed by cutting the substrate with a cutter. In one or more embodiments, for example, the slitting process may remove burrs generated in the electrode plate 110.

In one or more embodiments, the pressed electrode plate 110 is wound after undergoing slitting. The wound electrode plates 110 may form the electrode while being dried.

Hereinafter, an electrode manufacturing device and/or an electrode manufacturing method utilized to manufacture the electrode from the electrode plate 110 will be described.

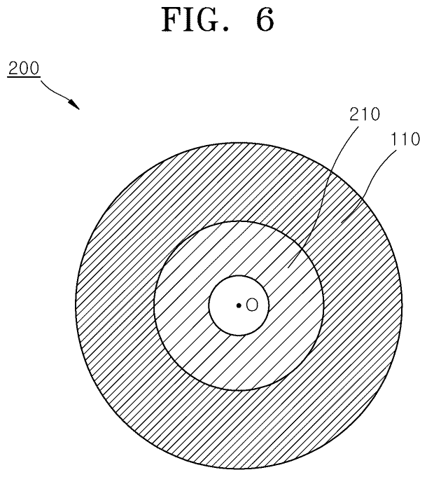

FIG. 6 is a view schematically showing how an electrode manufacturing device winds the electrode plate.

In FIG. 6, reference number 200 represents an electrode manufacturing device.

The electrode manufacturing device 200 is configured to wind the electrode plate 110. To this end, the electrode manufacturing device 200 may include a winding unit 210.

The winding unit 210 is configured to wind the electrode plate 110 around a mandrel portion O. In one or more embodiments, the winding unit 210 may have a cylindrical shape which is configured to rotate around the mandrel portion O. In one or more embodiments, the winding unit 210 is configured to rotate clockwise around the mandrel portion O. In one or more embodiments, the winding unit 210 may be configured to rotate counterclockwise around the mandrel portion O.

In one or more embodiments, the winding unit 210 is configured to ensure that the starting point S of the electrode plate is fixed to the winding unit 210. The winding unit 210 is configured to rotate such that the electrode plate 110 is wound around an outer circumferential surface of the winding unit 210 from the starting point S of the electrode plate 110. In this manner, the electrode plate 110 may be wound.

The electrode manufacturing device 200 is also configured to dry the wound electrode plate 110. To this end, the electrode manufacturing device 200 includes a drying unit.

The drying unit is configured to apply, for example, drying hot air to the wound electrode plate 110. For example, the drying unit is configured to perform vacuum drying of the electrode plate 110 through the drying hot air supplied into a chamber. In one or more embodiments, the drying hot air may be set to an appropriate temperature condition capable of removing a residual solvent, residual moisture, and the like from the electrode plate 110. For example, the drying unit may set the temperature conditions depending on a composition of the active material layer, a thickness of the active material layer, and the like.

In one or more embodiments, as the drying progresses, a spring back phenomenon of the electrode plate 110 occurs. The spring back phenomenon is a phenomenon in which the electrode plate 110 returns to a state before an external pressure is applied when left under a certain condition after pressing.

When the spring back phenomenon occurs, as an electrode density decreases, the energy density of the secondary battery 100 decreases. Further, when the spring back phenomenon occurs, since pressure between the electrodes increases in the secondary battery 100 designed with a certain volume, the secondary battery 100 may expand. Accordingly, the characteristics and/or safety of the secondary battery 100 may be lowered due to the spring back phenomenon.

In the wound electrode plate 110, as the mandrel region 111 receives pressure from the intermediate region 112 and the outer region 113, the spring back may not occur or may occur only to a relatively little extent (e.g., marginally). On the other hand, because the outer region 113 does not receive pressure from the outside, the spring back may occur to a relatively large extent. In this case, not only the spring back but also thickness variation occurs between the electrode plates 110.

A method according to one embodiment of the present disclosure is configured to cause the spring back not to occur or to rarely occur even after the drying of the electrode plate 110. Furthermore, a method according to one embodiment of the present disclosure is configured to control the thickness variation of the electrode plate 110. Hereinafter, an electrode manufacturing device and/or an electrode manufacturing method capable of preventing (or at least mitigating) the occurrence of the spring back in the electrode plate 110 and reducing the thickness variation of the electrode plate 110 will be described in detail.

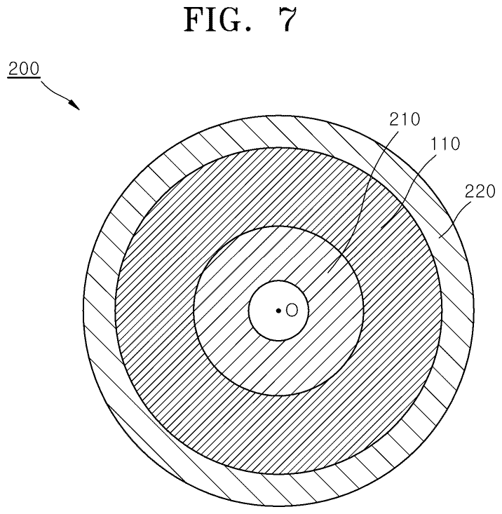

FIG. 7 is a view schematically showing how an electrode manufacturing device according to one embodiment of the present disclosure winds the electrode plate.

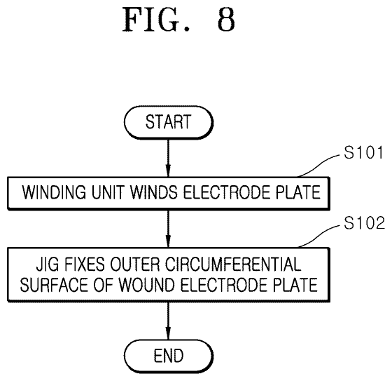

FIG. 8 is a flowchart describing aspects of an electrode manufacturing method according to one embodiment of the present disclosure.

The electrode manufacturing device 200 according to one embodiment of the present disclosure includes a winding unit 210 configured to wind an electrode plate 110 in which an active material layer is on a substrate, and a jig 220 which is configured to fix the outside of the wound electrode plate 110 and prevent (or at least mitigates) expansion of the electrode plate 110.

The electrode manufacturing device 200 is configured to wind the electrode plate 110. In one or more embodiments, the electrode plate 110 is a pressed electrode plate 110. In one or more embodiments, the electrode plate 110 may be in a slit state after being pressed. To this end, the electrode manufacturing device 200 includes the winding unit 210 and the jig 220.

As shown in FIG. 8, the electrode manufacturing method includes operation S101 in which the winding unit 210 winds the electrode plate 110 around the mandrel portion O. The description of the winding unit 210 is the same as or similar to description in FIG. 6.

In one or more embodiments, the winding unit 210 may be formed in a cylindrical shape which is configured to rotate around the mandrel portion O. In one or more embodiments, the winding unit 210 is configured to rotate clockwise around the mandrel portion O. In one or more embodiments, for example, the winding unit 210 is configured to rotate counterclockwise around the mandrel portion O.

For example, the winding unit 210 ensures that a starting point S of the electrode plate is fixed to the winding unit 210. The winding unit 210 rotates so that the electrode plate 110 may be wound around an outer circumferential surface of the winding unit 210 from the starting point S of the electrode plate 110. Accordingly, the electrode plate 110 may be wound. For example, the winding unit 210 may allow the electrode plate 110 to be wound around a circumferential surface of the winding unit 210 and form a plurality of layers.

As shown in FIG. 8, the electrode manufacturing method includes operation S102 in which the jig 220 fixes an outer circumferential surface of the wound electrode plate 110.

The jig 220 compresses the wound electrode plate 110. In one or more embodiments, the jig 220 may be provided along the outer circumferential surface of the wound electrode plate 110. The jig 220 is provided on the outer circumferential surface of the electrode plate 110 and applies pressure to the electrode plate 110 in operation S102. In one or more embodiments, the jig 220 applies pressure to the wound electrode plate 110 from the outside toward the inside in operation S102.

The jig 220 may have a cylindrical shape including a through hole therein. The through hole provides a space into which the wound electrode plate 110 may be inserted. In one or more embodiments, the jig 220 applies pressure to the wound electrode plate 110 inserted into the through hole.

In one or more embodiments, the jig 220 may be formed in a long thin plate shape and may form a cylindrical shape while being wound around the outer circumferential surface of the wound electrode plate 110. In one or more embodiments, for example, the jig 220 may be formed in a cylindrical shape including a through hole to which the wound electrode plate 110 may be fitted (e.g., inserted).

The jig 220 may apply a force to the electrode plate 110. For example, the jig 220 may apply pressure to an outer region 113 (shown in FIG. 5) of the wound electrode plate 110. Accordingly, the jig 220 may allow the electrode plate 110 to receive pressure in each of the regions (for example, including 111, 112, and 113). In one or more embodiments, the mandrel region 111 receives a force by the intermediate region 112, the outer region 113, and/or the jig 220. For example, in one or more embodiments, the outer region 113 receives a force by the jig 220.

In one or more embodiments, the jig 220 may uniformly (or substantially uniformly) apply pressure to the outer circumferential surface of the wound electrode plate 110. In one or more embodiments, the jig 220 may include an elastic material, a shape-deformed alloy, or the like. Accordingly, the jig 220 may allow the entire outer circumferential surface (or substantially the entire outer circumferential surface) of the wound electrode plate 110 to receive a uniform (or substantially uniform) pressure.

In this manner, the jig 220 may reduce spring back of the outer region 113 and/or improve the thickness variation of the electrode plate 110.

Further, the electrode manufacturing device 200 dries the wound electrode plate 110. To this end, the electrode manufacturing device 200 may further include a drying unit. The description of the drying unit is the same as or similar to description in FIG. 6.

As described above, the electrode plate 110 receives a force in each of the regions (for example, including 111, 112, and 113) by the jig 220 (i.e., the entirety of the electrode plate 110 receive the force from the jig 220). Accordingly, the spring back may not occur even when the drying of the electrode plate 110 progresses.

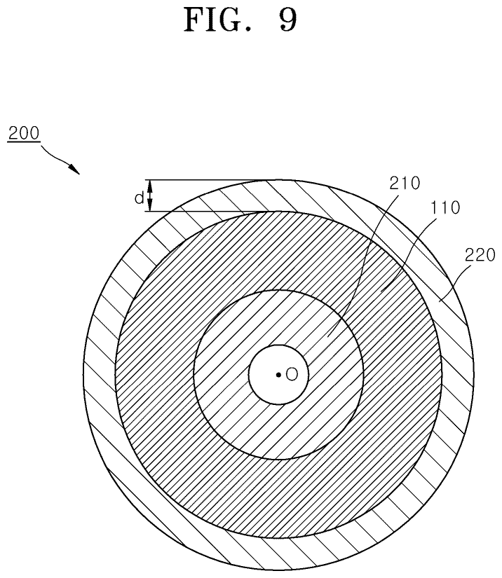

FIG. 9 depicts a jig according to one embodiment of the present disclosure.

In one or more embodiments, the jig 220 may include a metal foil wrapping the electrode plate 110 around the outer circumferential surface of the wound electrode plate 110.

In one or more embodiments, the electrode manufacturing device 200 further includes a driver configured to allow the metal foil to wrap the outside (outer circumferential surface) of the wound electrode plate 110.

The metal foil may be a rectangular thin plate having a length that is greater than a width. For example, in one or more embodiments, the length of the metal foil may be in a range from approximately 1 m to approximately 15 m, but the present disclosure is not limited thereto. A thickness of the metal foil may be thicker when the length is relatively shorter. The thickness of the metal foil may be thinner when the length is relatively longer.

The metal foil may wrap the wound electrode plate 110 once or a plurality of times. For example, as shown in FIG. 9, the metal foil may be wrapped around the outer circumferential surface of the wound electrode plate 110.

The metal foil may include a metal material. The metal foil may apply a sufficient pressure to the wound electrode plate 110.

In one or more embodiments, the metal foil may include a material that is the same as or similar to the substrate of the electrode plate 110. For example, in an embodiment in which the electrode plate 110 is a positive electrode plate, the substrate may include aluminum. In this embodiment, the metal foil may include aluminum. In an embodiment in which the electrode plate 110 is a negative electrode plate, the substrate may include copper and the metal foil may include copper.

However, the material included in the metal foil is not limited thereto, and for example, the metal foil may include stainless steel, titanium, copper, silver, chromium, nickel, iron, cobalt, and/or an alloy thereof.

FIG. 9 shows an example in which the metal foil wraps the wound electrode plate 110 once or a plurality of times and the entire jig 220 has a thickness d. In an embodiment in which the metal foil wraps the electrode plate 110 once, the thickness d of the jig is the same as the thickness of the metal foil. In an embodiment in which the metal foil wraps electrode plate 110 n times (in this case, n is a natural number greater than or equal to 2), the thickness d of the jig is n times the thickness of the metal foil.

The thickness d of the jig may be, for example, approximately 300 μm or more. When the thickness d of the jig is less than approximately 300 μm, the jig 220 may not provide a sufficient pressure to the electrode plate 110. In such a case, the jig 220 may not control expansion of the electrode plate 110 even when the jig 220 is wound around the circumferential surface of the electrode plate 110. For example, the jig 220 may not sufficiently reduce the spring back of the electrode plate 110 when the thickness d of the jig is less than approximately 300 μm. Accordingly, in one or more embodiments, the thickness (d) of the jig is approximately 300 μm or more.

Through this configuration, the jig 220 may provide a sufficient pressure to the electrode plate 110. For example, the jig 220 may reduce the spring back of the electrode plate 110. Further, the jig 220 may control the thickness variation of the dried electrode plate 110. In one or more embodiments, for example, the dried electrode plate 110 may have a thickness ratio in a range from approximately 99:100 to approximately 100:100 between the mandrel region 111 and the outer region 113.

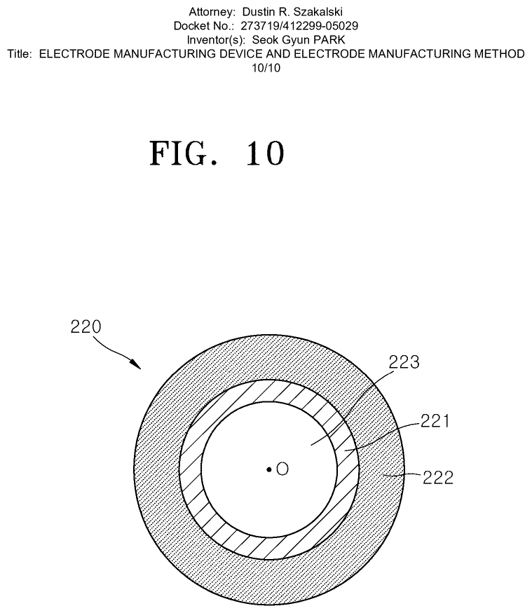

FIG. 10 depicts a jig according to one embodiment of the present disclosure.

In one or more embodiments, the jig 220 may include a structure including a through hole 223 into which the wound electrode plate 110 is inserted.

The structure may include a first layer 222 forming an exterior of the structure, and a second layer 221 located at a center portion of the structure and forming the through hole 223 in the structure.

The first layer 222 forms the exterior of the structure. The first layer 222 may include a material having sufficient rigidity such that the structure may sufficiently compress the electrode plate 110.

In one or more embodiments, the first layer 222 may include at least one of a metal, a polymer, a fiber, or a fiber including metal and/or a polymer.

In one or more embodiments, the metal includes, for example, a material included in the substrate. In one or more embodiments, the metal includes, for example, a material with high tensile strength. In one or more embodiments, the metal may include, for example, any suitable type of metal such as gold, silver, aluminum, copper, tungsten, nickel, platinum, tin, titanium, stainless steel (STS), chromium, vanadium, Inconel, or the like.

In one or more embodiments, the polymer includes, for example, a material having a tensile strength (D638) of approximately 500 kg/cm² or more.

In one or more embodiments, the polymer includes, for example, at least one or a mixture of at least two or more materials selected from the group consisting of acrylonitrile butadiene styrene (ABS), styrene acrylonitrile (SAN), polystyrene, modified polyphenylene oxide (MPPO), polycarbonate, polysulfone, polyetherimide, acetal, polybutyrene terephthalate resin (PBT), nylon6, nylon66, nylon 46, nylon 610, nylon 612, nylon 11, nylon12, amorphous nylon, polyphthalamide (PPA), polyetheretherketone, and polyphenylene sulfide.

In one or more embodiments, the fibers include, for example, at least one or a mixture of at least two or more materials selected from the group consisting of glass wool, rock wool, glass fibers, rock fibers, gypsum fibers, silica fibers, alumina fibers, zirconia fibers, and carbon fibers which are inorganic materials in the form of fibers. In one or more embodiments, the fibers are, for example, fiber-type metal material, and include, for example, at least one or a mixture of at least two or more materials selected from the group consisting of gold, silver, iron, steel, aluminum, beryllium, tungsten, molybdenum, and stainless steel which are formed in the form of fibers.

The second layer 221 may include a material the same as the material included in the substrate.

For example, in an embodiment in which the electrode plate 110 is a positive electrode plate, as described in FIGS. 1 to 4, the substrate included in the electrode plate 110 may include, for example, aluminum. In this embodiment, the second layer 221 may include aluminum. Further, for example, in an embodiment in which the electrode plate 110 is a negative electrode plate, as described in FIGS. 1 to 4, the substrate included in the electrode plate 110 may include, for example, copper. In this embodiment, the second layer 221 may include copper.

An inner circumferential surface of the second layer 221 may be smoothly formed. Accordingly, the second layer 221 allows the wound electrode plate 110 to be inserted into the through hole 223 without damaging the active material layer. For example, in one or more embodiments, a friction coefficient of the second layer 221 may be approximately 1 or less.

The electrode manufacturing device 200 may further include a driver which allows the structure to insert the wound electrode plate 110 into the through hole 223. The driver may, for example, insert the wound electrode plate 110 into the through hole 223.

In one or more embodiments, as described in FIG. 9, the thickness of the jig 220 may be, for example, approximately 300 μm or more. The thickness d of the jig represents the shortest distance from an inner circumferential surface of the first layer 222 to an outer circumferential surface of the second layer 221. That is, the thickness d of the jig is the sum of the thickness of the first layer 222 and the thickness of the second layer 221.

In one or more embodiments, the thickness of the second layer 221 may be greater than the thickness of the first layer 222. However, the present disclosure is not limited thereto.

When the thickness d of the jig is less than 300 μm, the jig 220 may not provide a sufficient pressure to the electrode plate 110. In this case, the jig 220 may not control the expansion of the electrode plate 110 even when the jig 220 is wound around the circumferential surface of the electrode plate 110. For example, the jig 220 may not sufficiently reduce the spring back of the electrode plate 110. Accordingly, in one or more embodiments, the thickness d of the jig may be approximately 300 μm or more.

In one or more embodiments, unlike as shown in FIG. 10, the structure may include only the second layer 221. In this embodiment, the structure may include the second layer 221 having a thickness of approximately 300 μm or more.

Through this configuration, the jig 220 may provide a sufficient pressure to the electrode plate 110. For example, the jig 220 may reduce the spring back of the electrode plate 110. Further, the jig 220 may control the thickness variation of the dried electrode plate 110. Accordingly, for example, the dried electrode plate 110 may have a thickness ratio in a range from approximately 99 to approximately 100:100 between the mandrel region 111 and the outer region 113.

Table 1 and Table 2 below show the thickness measured in each of the mandrel region 111, the intermediate region 112, and the outer region 113 after the wound electrode plate 110 is dried. Table 1 shows a comparative example in which the electrode plate 110 is wound utilizing an electrode manufacturing device with a jig having a thickness of 20 μm. Table 2 shows an embodiment in which the electrode plate 110 is wound utilizing an electrode manufacturing device 200 with a jig 220 having a thickness of 300 μm.

TABLE 1

| | Outer | | Mandrel |
|---|---|---|---|
| Comparative | region | Intermediate | region |
| Example | (μm) | region (μm) | (μm) |
| 1 | 123.0 | 121.0 | 121.0 |
| 2 | 123.0 | 121.0 | 121.0 |
| 3 | 123.0 | 121.0 | 121.0 |
| 4 | 124.0 | 121.0 | 121.0 |
| 5 | 123.0 | 121.0 | 121.0 |
| 6 | 125.0 | 121.0 | 121.0 |
| 7 | 123.0 | 121.0 | 121.0 |
| 8 | 123.0 | 121.0 | 121.0 |
| 9 | 123.0 | 121.0 | 121.0 |
| 10 | 125.0 | 121.0 | 121.0 |
| Average | 123.5 | 121.0 | 121.0 |
| Spring | 5 | 2 | 2 |
| back (μm) | | | |

In Table 1, an average thickness of the electrode plate 110 after pressing and before drying is approximately 118.9 μm.

As can be seen in Table 1, spring back occurred in the outer region 113 in the dried electrode plate 110 that was formed without utilizing the jig 220 according to one embodiment of the present disclosure.

Further, it can be seen that the outer region of the electrode plate 110 described in Table 1 is formed with a thickness of approximately 102.1% or more of the mandrel region.

Accordingly, it can be seen that it is difficult to control the thickness variation of the electrode plate 110 through the electrode manufacturing device according to the comparative example (i.e., utilizing a jig having a thickness of only 20 μm).

TABLE 2

| | Outer | | Mandrel |
|---|---|---|---|
| | region | Intermediate | region |
| Example | (μm) | region (μm) | (μm) |
| 1 | 122.0 | 121.0 | 121.0 |
| 2 | 121.0 | 121.0 | 121.0 |
| 3 | 122.0 | 121.0 | 121.0 |
| 4 | 122.0 | 121.0 | 122.0 |
| 5 | 121.0 | 121.0 | 121.0 |
| 6 | 122.0 | 121.0 | 121.0 |
| 7 | 122.0 | 121.0 | 121.0 |
| 8 | 121.0 | 121.0 | 121.0 |
| 9 | 122.0 | 121.0 | 121.0 |
| 10 | 121.0 | 121.0 | 121.0 |
| Average | 121.6 | 121.0 | 121.0 |
| Spring | 2 | 2 | 2 |
| back (um) | | | |

In Table 2, an average thickness of the electrode plate 110 after pressing and before drying is 118.9 μm. Further, in Table 2, a jig 220 including a metal foil including copper and having a thickness of approximately 300 μm according to one embodiment of the present disclosure was utilized to manufacture the electrode plate.

As can be seen in Table 2, the spring back did not occur or very slightly occurred (e.g., marginally) in the outer region 113 in the dried electrode plate 110 in a state in which the jig 220 according to one embodiment of the present disclosure is applied. Further, it can be seen that the electrode plate 110 described in Table 2 is has a thickness ratio in a range from approximately 99 to approximately 100:100 between the outer region 113 and the mandrel region 111. Accordingly, it can be seen that the electrode manufacturing device 200 according to one embodiment of the present disclosure may control the thickness variation of the electrode plate 110.

As can be seen through Tables 1 and 2, the electrode manufacturing device 200 may reduce the spring back of the electrode plate 110 and control the thickness variation by including the jig 220. Further, the electrode manufacturing device 200 may further reduce the spring back of the electrode plate 110 and more effectively control (e.g., minimize or at least reduce) the thickness variation across the electrode plate 110 by including the jig 220 having a thickness of approximately 300 μm or more.

According to the present disclosure, an electrode manufacturing device and/or an electrode manufacturing method which manufacture an electrode in which the spring back of an electrode plate is controlled (e.g., minimized or at least reduced) can be provided.

According to the present disclosure, an electrode manufacturing device and/or an electrode manufacturing method which manufacture an electrode in which thickness variation of an electrode plate is improved can be provided.

However, technical effects acquirable through the present disclosure are not limited to the above-described technical effects, and other technical effects which are not mentioned will be clearly understood by those skilled in the art from the description of the invention described below.

Although the present disclosure has been described above by limited embodiments and drawings, the present disclosure is not limited thereto, and various modifications and variations may be made by those skilled in the art within the spirit of the present disclosure and the equivalent scope of the claims to be described below.

What is claimed is:

1. An electrode manufacturing device, comprising:
a winding unit configured to wind an electrode plate including an active material layer on a substrate into a wound electrode plate; and
a jig configured to fix an outside of the wound electrode plate and prevent expansion of the wound electrode plate.

2. The electrode manufacturing device of claim 1, wherein:
the jig includes a metal foil wrapping around an outer circumferential surface of the wound electrode plate; and
the electrode manufacturing device further includes a driver configured to allow the metal foil to wrap the outer circumferential surface of the wound electrode plate.

3. The electrode manufacturing device of claim 2, wherein the metal foil wraps the wound electrode plate a plurality of times.

4. The electrode manufacturing device of claim 1, wherein the jig includes a structure including a through hole into which the wound electrode plate is configured to be inserted.

5. The electrode manufacturing device of claim 4, wherein the structure includes a first layer forming an exterior of the structure, and a second layer located at a center portion of the structure and forming the through hole in the structure.

6. The electrode manufacturing device of claim 5, wherein the first layer includes at least one of a metal or a polymer.

7. The electrode manufacturing device of claim 6, wherein the polymer has a tensile strength of at least approximately 500 kg/cm².

8. The electrode manufacturing device of claim 5, wherein the second layer includes a material same as a material included in the active material layer.

9. The electrode manufacturing device of claim 5, wherein the second layer has a friction coefficient of approximately 1 or less between the wound electrode plate and an inner circumferential surface of the structure.

10. The electrode manufacturing device of claim 1, wherein the jig has a thickness of approximately 300 μm or more.

11. The electrode manufacturing device of claim 1, wherein the jig is configured to press the wound electrode plate.

12. The electrode manufacturing device of claim 1, further comprising a drying unit configured to dry the wound electrode plate to form a dried electrode plate.

13. The electrode manufacturing device of claim 12, wherein the dried electrode plate has a thickness ratio in a range from approximately 99:100 to approximately 100:100 between a mandrel region and an outer region of the dried electrode plate.

14. An electrode manufacturing method comprising:
winding, by a winding unit, an electrode plate to form a wound electrode plate; and
fixing, by a jig, an outer circumferential surface of the wound electrode plate to form a fixed electrode plate.

15. The method of claim 14, wherein:
the jig includes a metal foil; and
the fixing of the outer circumferential surface of the wound electrode plate by the jig includes wrapping, with the metal foil, the outer circumferential surface of the wound electrode plate a plurality of times.

16. The method of claim 14, wherein:
the jig includes a structure including a through hole; and
the fixing of the outer circumferential surface of the wound electrode plate by the jig includes fitting the wound electrode plate into the through hole of the structure.

17. The method of claim 16, wherein the structure includes a first layer forming an exterior of the structure, and a second layer located at a center portion of the structure and forming the through hole in the structure.

18. The method of claim 14, wherein the jig has a thickness of at least approximately 300 μm.

19. The method of claim 14, further comprising drying, by a drying unit, the fixed electrode plate to form a dried electrode plate.

20. The method of claim 19, wherein the dried electrode plate has a thickness ratio in a range from approximately 99:100 to approximately 100:100 between a mandrel region and an outer region of the dried electrode plate.
